(19) United States
(12) Patent Application Publication
(10) Pub. No.: US 2012/0082752 A1
(43) Pub. Date: Apr. 5, 2012

(54) PLASTIC INJECTION MOLD

(75) Inventors: Jian-ming Li, Tu Cheng (TW); Xiao-ping Wu, Tu Cheng (TW); Shih-hsiung Ho, Tu Cheng (TW)

(73) Assignee: Cheng Uei Precision Industry Co., LTD., Tu Cheng City (TW)

(21) Appl. No.: 12/895,604

(22) Filed: Sep. 30, 2010

(51) Int. Cl. B29C 45/40

(52) U.S. Cl. 425/556

(57) ABSTRACT

A plastic injection mold is provided for use in a mold injection machine. The plastic injection mold includes a stationary mold member, a movable mold member mating the stationary mold member, an ejection mechanism disposed on the movable mold member, and a resetting device mounted to the movable mold member. The resetting device is provided to ensure complete return of ejector elements that constitute the ejection mechanism back to the home position before the plastic injection mold is to be closed again. As such, damage caused by undesired impact between of the ejector elements and other mold elements can be avoided, thereby ensuring operation safety of the plastic injection mold in a closing operation.

### TECHNICAL FIELD OF THE INVENTION

The present invention relates to a mold, and especially to a plastic injection mold.

### BACKGROUND OF THE INVENTION

Referring to FIG. 4, a conventional plastic injection mold 80 comprises a movable mold member 81 and a stationary mold member 82. The movable mold member 81 comprises a movable mold fixing plate 811, two spacer plates 812, an ejector plate 813, an ejector retainer plate 814, a plurality of ejector elements 815, a movable platen 816, a mold core 817 mounted on the movable platen 816, and a slide 818 mating the mold core 817 for molding purposes. An inclined guide pillar 821 is mounted to the stationary mold member 82 and is insertable into the slide 818 of the movable mold member 81. The ejector elements 815 are disposed on the ejector plate 813. One end of each ejector element 815 is fixed to the ejector retainer plate 814, and the other is inserted into the mold core 817.

In ejecting and returning processes of the ejector plate 813 of the plastic injection mold 80, it cannot be ensured that the ejector element 815 can completely return to the original position. Accordingly, the ejector element 815 may collide with the mold core 817, the slide 818, and other mold elements to cause damage and safety of the mold in a closing operation cannot be ensured.

### SUMMARY OF THE INVENTION

An objective of the present invention is to provide a plastic injection mold, which ensures that an ejector element can completely return to a home position in a returning process in order to overcome the drawback of the above-mentioned prior art.

To achieve the foregoing objective, according to the present invention, a plastic injection mold is provided for use with an injection molding machine and comprising a stationary mold member, a movable mold member mating the stationary mold member, an ejection mechanism, and a resetting device. The movable mold member comprises a movable mold fixing plate and a movable platen with the movable mold fixing plate being arranged to oppose and spaced from the movable platen. A receiving hole is defined in the movable mold fixing plate. The ejection mechanism is disposed on the movable mold and comprises an ejector plate and a plurality of ejector elements. The ejector elements are mounted on the ejector plate. The ejector plate and the ejector elements are moveable between the movable mold fixing plate and the movable platen. The resetting device is disposed on the movable mold member and comprises an ejector return pin having one end extending through the receiving hole and fixed to the ejector plate and an opposite end coupleable to the injection molding machine.

As mentioned above, according to the present invention, the resetting device is provided and mounted to the movable mold member of the plastic injection mold, so that the ejector elements can completely return back to the home position before the plastic injection mold is being closed.

### BRIEF DESCRIPTION OF THE DRAWINGS

FIG. 1 is a cross-sectional view illustrating a plastic injection mold according to the present invention in a closed condition;

FIG. 2 is a cross-sectional view illustrating the plastic injection mold according to the present invention in an open condition;

FIG. 3 is an exploded view illustrating a resetting device of the plastic injection mold shown in FIG. 2; and

FIG. 4 is a cross-sectional view illustrating a conventional plastic injection mold in a closed condition.

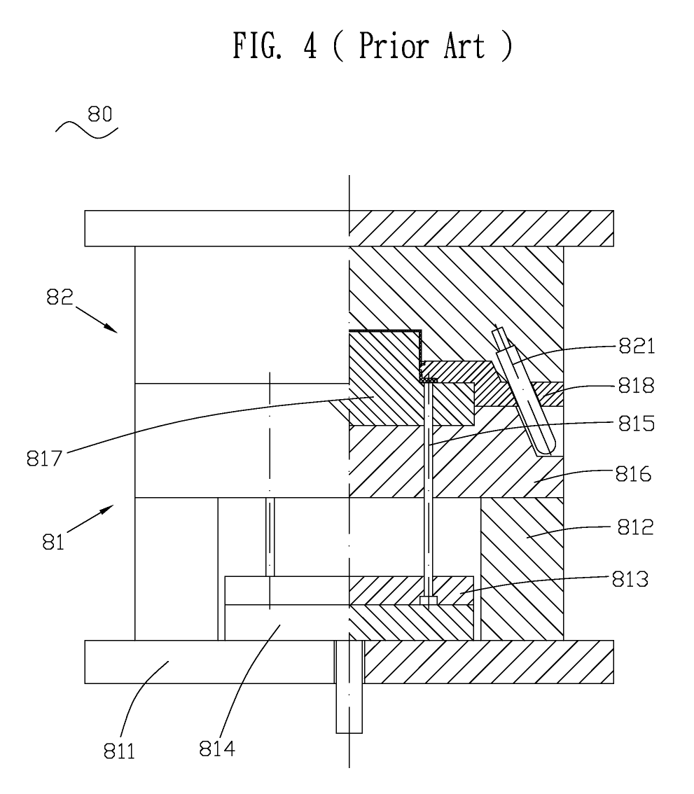

### DETAILED DESCRIPTION OF THE PREFERRED EMBODIMENT

Reference will now be made in detail to the present preferred embodiment of the invention, an example of which is illustrated in the accompanying drawings.

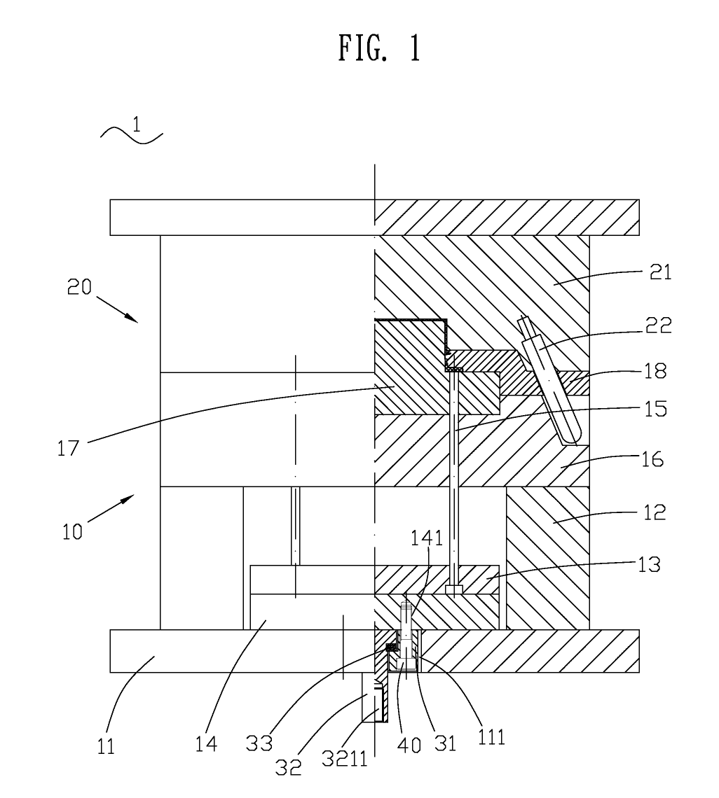

As shown in FIG. 1, a plastic injection mold according to the present invention, generally designated at 1, comprises a movable mold member 10, a stationary mold member 20, and a resetting device 30.

The movable mold member 10 comprises a movable mold fixing plate 11, two spacer plates 12, an ejector plate 13, an ejector retainer plate 14, a plurality of ejector elements 15, a movable platen 16, a mold core 17 mounted on the movable platen 16, and a slide 18 mating the mold core 17 for molding a workpiece. A receiving hole 111 is formed in the movable mold fixing plate 11. A plurality of internally-threaded holes 141 is defined in the ejector retainer plate 14. The spacer plates 12 are fixed on the movable mold fixing plate 11 to support the movable platen 16 thereon. The ejector elements 15 are fixed to the ejector plate 13. The ejector plate 13 and the ejector retainer plate 14 are moveable between the movable mold fixing plate 11 and the movable platen 16 along the spacer plates 12. The slide 18 is movably disposed on the movable platen 16.

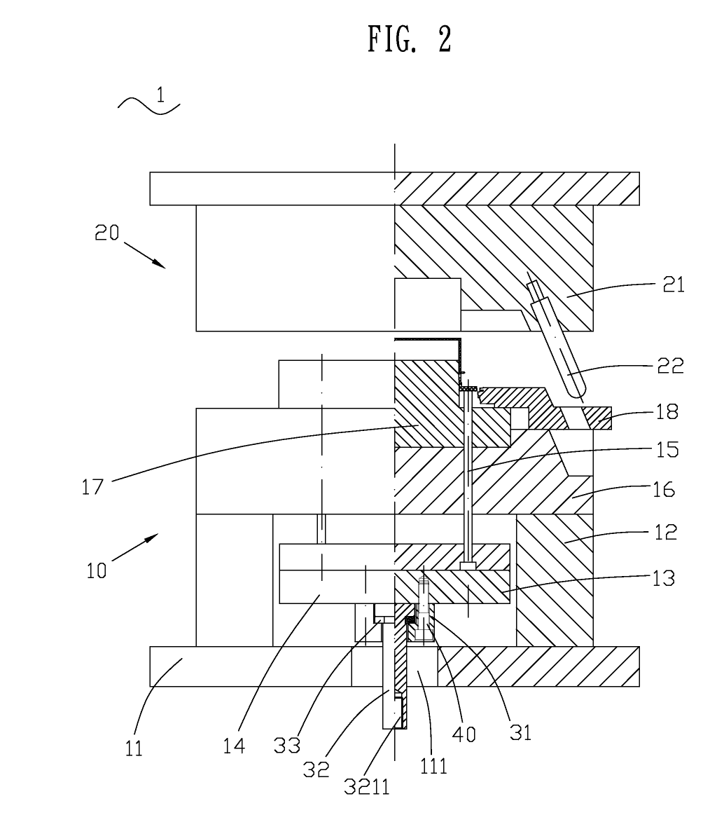

Referring to FIGS. 1 and 2, the stationary mold member 20 comprises a stationary platen 21 and an inclined guide pillar 22 fixed on the stationary platen 21. In the processes of the plastic injection mold 1 opening and closing, the inclined guide pillar 22 is movably fit into the slide 18 of the movable mold member 10.

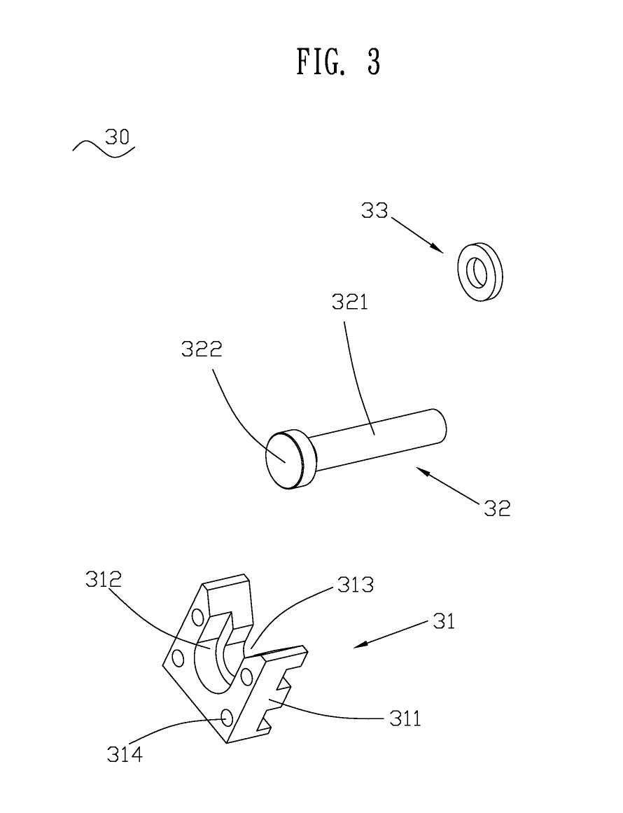

Referring to FIGS. 1 and 3, the resetting device 30 comprises a fixing block 31, an ejector return pin 32 received in the fixing block 31, and a ring 33 made of elastomeric materials. The fixing block 31 has a square base 311, which defines in one end thereof a recessed, U-shaped chamber 312 having a bottom through which a slot 313, preferably having a rounded inner closed end and an opposite outer open end and thus forming a U-shape, is defined. A plurality of screw holes 314 is defined in the base 311 and arranged around the chamber 312. The ejector return pin 32 has a base rod 321 and a holding portion 322 connected to an end of the base rod 321. An internally-threaded connection hole 3211 is defined in an opposite end of the base rod 321.

Referring to FIG. 1, in assembling the plastic injection mold 1, the resetting device 30 is assembled to the movable mold member 10 with a bolt 40 received through each of the screw holes 314 of the resetting device 30 and each of the internally-threaded holes 141 of the ejector retainer plate 14 to fix the fixing block 31 of the resetting device 30 to the movable mold member 10. Then, the ring 33 of the resetting device 30 is fit over the base rod 321 of the ejector return pin 32, and the ejector return pin 32 and the ring 33 are inserted into the fixing block 31 with the ring 33 and the holding portion 322 of the ejector return pin 32 received in and retained by the chamber 312 of the fixing block 31. The ring 33, which is made of elastomeric materials, helps cushioning an excessive pull-back force to protect the ejector retainer plate 14 from undesired excessive deformation. A portion of the base rod 321 is received in the slot 313. The ejector return pin 32 is mounted to the fixing block 31 in a removable manner so as to facilitate mounting and removal of the ejector return pin 32 to and from the fixing block 31 and thus improving productivity. Then, the base rod 321 is connected to an ejector rod (not shown) of an injection molding machine through the internally-threaded connection hole 3211.

In the processes of the plastic injection mold 1 opening, when the movable mold member 10 is separated from the stationary mold member 20, the slide 18 is detached from a molded product by the inclined guide pillar 22, and then the ejector rod of the injection molding machine pushes the resetting device 30 thereby driving the ejector plate 13 and the ejector retainer plate 14 to move up for the ejector elements 15 ejecting the molded product. In the processes of the plastic injection mold 1 closing, the fixing block 31 of the resetting device 30 is pulled back into the receiving hole 111 of the movable mold fixing plate 11 by the ejector rod of the injection molding machine, thereby making the ejector elements 15 completely returning back to the position before ejecting. The movable mold member 10 and the stationary mold member 20 may then be closed, wherein the slide 18 is returned to the position before the mold is opened by the inclined guide pillar 22. This ensures no undesired impact occurring between the ejector elements 15 and the slide 18 and damage so caused on the ejector elements 15 and the slide 18 is definitely eliminated.

As mentioned above, according to the present invention, the movable mold member 10 of the plastic injection mold 1 is provided with a resetting device 30, which helps returning the ejector element 15 completely back to the designated position before the plastic injection mold 1 is closed. As a result, undesired impact between the ejector elements 15 and the slide 18 can be definitely avoided, thereby ensuring the safety of the plastic injection mold 1 in a closing operation.

While the preferred embodiment of the present invention has been illustrated and described in detail, various modifications and alterations can be made by persons skilled in this art. For instance, the ejector return pin can be fixed on ejector rod of the injection molding machine for being subsequently coupled to the fixing block, or the ejector return pin can be directly fixed to the ejector retainer plate. Such modifications and alterations that maintain the spirit and realm of the present invention are within the scope of the present invention as defined in the appended claims.

What is claimed is:

1. A plastic injection mold for use in an injection molding machine, comprising:
a stationary mold member;
a movable mold member, which is mating with the stationary mold member, the movable mold member comprising a movable mold fixing plate and a movable platen, the movable mold fixing plate opposing and spaced from the movable platen, a receiving hole being defined in the movable mold fixing plate;
an ejection mechanism, which is disposed on the movable mold member, the ejection mechanism comprising an ejector plate and a plurality of ejector elements, the ejector elements being fixed on the ejector plate, the ejector plate and the ejector elements being moveable between the movable mold fixing plate and the movable platen; and
a resetting device, which is disposed on the movable mold member, the resetting device comprising an ejector return pin having an end extending through the receiving hole and fixed to the ejector plate and an opposite end adapted to couple to the injection molding machine.

2. The plastic injection mold of claim 1, wherein the resetting device comprises a fixing block having a base, which defines in an end thereof a chamber having a bottom through which a slot in defined, the ejector return pin having a base rod and a holding portion connected to the base rod, the ejector return pin being insertable into the fixing block to have the holding portion received in and retained by the chamber of the fixing block, the base rod being received in the slot.

3. The plastic injection mold of claim 2, wherein the ejector return pin is movably disposed on fixing block.

4. The plastic injection mold of claim 2, wherein a plurality of screw holes is defined in the base around the chamber, an ejector retainer plate being fixed to the ejector plate and defining a plurality of internally-threaded holes, bolts being received through the screw holes and engaging the internally-threaded holes.

5. The plastic injection mold of claim 2, wherein a resilient ring is fit over the base rod of the ejector return pin.

6. The plastic injection mold of claim 2, wherein an internally-threaded connection hole is defined in an end of the base rod for coupling to the injection molding machine.
